(19) United States
(12) Patent Application Publication
(10) Pub. No.: US 2008/0067914 A1
(43) Pub. Date: Mar. 20, 2008

(54) PLASMA DISPLAY APPARATUS AND MANUFACTURING METHOD OF ELECTROMAGNETIC WAVE INTERFERENCE BLOCKING FILTER THEREFOR

(75) Inventors: Hyunchul Kim, Seoul (KR); Myungwon Lee, Seoul (KR); Jinsan Moon, Seoul (KR); Jungchul Shin, Seoul (KR)

Correspondence Address: FISH & RICHARDSON P.C., P.O. BOX 1022, MINNEAPOLIS, MN, 55440-1022, US

(73) Assignee: LG ELECTRONICS INC., Seoul (KR)

(21) Appl. No.: 11/856,904

(22) Filed: Sep. 18, 2007

(30) Foreign Application Priority Data
Sep. 18, 2006 (KR) 10-2006-0090341
Sep. 18, 2006 (KR) 10-2006-0090342

(51) Int. Cl. H01J 17/49; H01J 9/00

(52) U.S. Cl. 313/493; 29/527.2

(57) ABSTRACT

A plasma display apparatus comprises: a front panel comprising scan electrodes and sustain electrodes; a rear panel comprising data electrodes intersecting the scan electrodes and the sustain electrodes, and coupled in parallel to the front panel at a given distance therefrom; barrier ribs disposed between the front panel and the rear panel in order to form discharge cells; phosphors formed within the discharge cells, for emitting visible rays; and an electromagnetic wave interference blocking filter arranged on top of the front panel, the electromagnetic wave interference blocking filter comprising a base layer and a metallic layer of a mesh pattern disposed with a differential thickness on the base layer.

This nonprovisional application claims priority under 35 U.S.C. § 119(a) on Patent Application Nos. 10-2006-00090341 and 10-2006-0090342 filed in Republic of Korea on Sep. 18, 2006 the entire contents of which are hereby incorporated by reference.

### BACKGROUND

1. Field

This document relates to a plasma display apparatus and a manufacturing method of an electromagnetic interference filter therefor.

2. Related Art

In general, a plasma display apparatus comprises a plasma display panel for displaying images using plasma discharge and a display filter disposed on the front surface of the plasma display panel.

A plasma display panel generally comprises a front panel and a rear panel. Barrier ribs formed between the front panel and the rear panel define unit discharge cells. Each of the unit discharge cells is filled with an inert gas containing a main discharge gas such as neon (Ne), helium (He) or a Ne—He gas mixture and a small amount of xenon (Xe). The plurality of unit discharge cells constitute a single pixel. For example, a red cell, a green cell, and a blue cell are gathered to constitute a pixel.

When a high frequency voltage is applied to the unit discharge cells to generate a discharge, the discharged inert gas radiates vacuum ultraviolet rays. These ultraviolet rays excite phosphors formed between the barrier ribs to display images.

A filter with the functions of a color correction film or an electromagnetic wave interference blocking film for blocking harmful electromagnetic wave is arranged on the front surface of the display panel to further improve the quality of images. The functionality and structure of this filter have been studied continuously.

### SUMMARY

Accordingly, an aspect of this document is to provide a plasma display apparatus, which can improve the contrast characteristic, and a manufacturing method of an electromagnetic interference filter therefor.

In an aspect, a plasma display apparatus comprises: a front panel comprising scan electrodes and sustain electrodes; a rear panel comprising data electrodes intersecting the scan electrodes and the sustain electrodes, and coupled in parallel to the front panel at a given distance therefrom; barrier ribs disposed between the front panel and the rear panel in order to form discharge cells; phosphors formed within the discharge cells, for emitting visible rays; and an electromagnetic wave interference blocking filter arranged on top of the front panel, the electromagnetic wave interference blocking filter comprising a base layer and a metallic layer of a mesh pattern disposed with a differential thickness on the base layer.

Implementations may include one or more of the following features. For example, the mesh pattern of the metallic layer may have a polygonal cross section.

The base layer may comprise a cushioning material.

The surface of the mesh pattern may have a dark color.

In another aspect, a manufacturing method of an electromagnetic wave interference blocking filter for a plasma display apparatus comprises: forming a base layer having recesses of a mesh pattern by applying resin on top of a mold having projections of a mesh pattern; forming a metallic layer of a mesh pattern by applying a metallic material on top of the base layer; and forming a film or glass substrate on the rear surface of the base layer.

Implementations may include one or more of the following features. For example, the base layer may further comprise one or more of near infrared blocking materials and color correction materials.

The metallic layer may comprise carbon.

The thickness of the metallic layer of the mesh pattern may be differential.

It is to be understood that both the foregoing general description and the following detailed description area exemplary and explanatory and area intended to provided further explanation of the invention as claimed.

### BRIEF DESCRIPTION OF THE DRAWINGS

The invention will be described in detail with reference to the following drawings in which like numerals refer to like elements.

FIG. 1 is a view of illustrating a construction of a plasma display apparatus according to an embodiment of the present invention;

FIG. 2 is a view showing an example of a structure of a plasma display panel of the present invention;

FIG. 3 is a view showing a cross section of a display filter structure according to an embodiment of the present invention;

FIGS. 4a and 4b are views showing a plane of a display filter structure according to an embodiment of the present invention;

FIGS. 5a and 5b are views showing a stereoscopic structure of a mesh pattern when the mesh pattern of a metallic layer has a rectangular shape;

FIGS. 6a and 6b are views showing a stereoscopic structure of a mesh pattern when the mesh pattern of a metallic layer has a hexagonal shape; and

FIGS. 7a and 7b are views for explaining a manufacturing method of a display filter according to an embodiment of the present invention.

### DETAILED DESCRIPTION

Preferred embodiments of the present invention will be described in a more detailed manner with reference to the drawings.

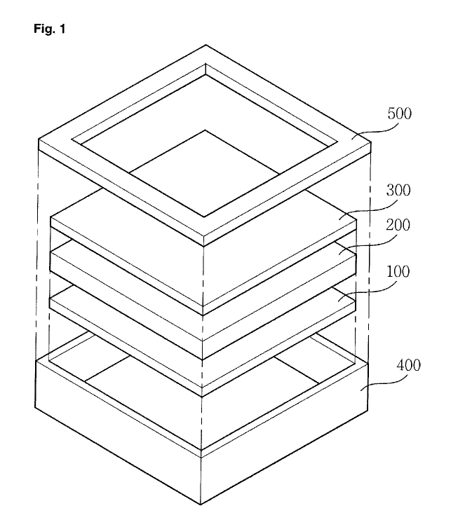

FIG. 1 is a view of illustrating a construction of a plasma display apparatus according to an embodiment of the present invention.

As shown in FIG. 1, the plasma display apparatus according to an embodiment of the present invention comprises a case 400, a cover 500 for covering the top of the case, a driving circuit substrate 100 located between the case and the cover, a plasma display panel 200, and a display filter 300.

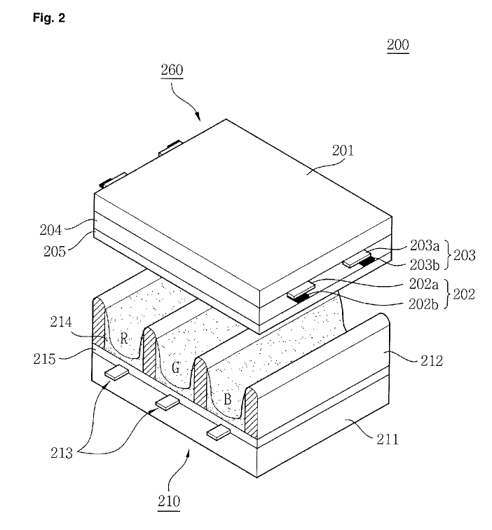

The plasma display panel 200 comprises a plurality of electrodes, e.g. scan electrodes Y, sustain electrodes Z, and address electrodes X. Driving units (not shown) provided on a driving circuit substrate 100 apply a driving voltage to these electrodes to create a discharge, thereby displaying images. An example of the structure of the plasma display panel 200 of this type will be described in detail in FIG. 2.

FIG. 2 is a view showing an example of a structure of a plasma display panel of the present invention.

As shown in FIG. 2, as an example, the plasma display panel comprises a front panel 260 and a rear panel 210 which are coupled in parallel to be opposed to each other at a given distance therebetween. The front panel 260 comprises a front substrate 201 being a display surface on which images are displayed, and the rear panel 210 comprises a rear substrate 221 being a rear surface. Scan electrodes 202 and Y and sustain electrodes 203 and Z are formed in pairs on the front substrate 201 to form a plurality of maintenance electrode pairs. A plurality of data electrodes 213 and X are arranged on the rear substrate 211 to intersect the plurality of maintenance electrode pairs.

The front panel 260 may comprise a pair of a scan electrode 202 and Y and a sustain electrode 203 and Z for causing a reciprocal discharge to occur at a discharge cell and maintaining the light emission of the discharge cell. The scan electrode and sustain electrode each are composed of a transparent electrode 202a and 203a made of a transparent ITO material and a bus electrode 202b and 203b made of a metallic material. The scan electrode and sustain electrode each may be formed only of either transparent electrodes or bus electrodes.

The scan electrode 202 and Y and sustain electrode 203 and Z are covered with one or more upper dielectric layers 204 which serve to confine the discharge current and insulate between the electrode pairs. And, a protective layer 205, which are deposited by, e.g. MgO, is formed on the upper dielectric layers 204 to mitigate the conditions for discharge.

A stripe-type or well-type of barrier ribs 212 are arranged on the rear panel 210 in order to form a plurality of discharge cells. These ribs may be included in the front panel. In addition, the rear panel 210 comprises a plurality of data electrodes 213 and X, and the data electrodes are arranged in parallel with the barrier ribs 212 to generate an address discharge, thereby radiating vacuum ultraviolet rays. R, G, and B phosphors 214 are applied within the discharge cells to emit visible rays for displaying images upon an address discharge. A lower dielectric layer 215 is formed between the data electrodes 213 and X and phosphors 214 to protect the data electrodes 213 and X.

The thusly formed front panel 260 and rear panel 210 are combined to each other by sealing process to form a plasma display panel. Then, although not shown, a driving circuit substrate 120 is disposed on the rear surface of the plasma display panel, on which driving units (not shown) are formed to supply a driving voltage to the scan electrodes 202 and Y, sustain electrodes 203 and Z, and data electrodes 213 and X.

When the plasma display panel 100 is driven, the driving units (not shown) supply the electrodes of the plasma display panel with a reset pulse in a reset period, a scan pulse in an address period, and a driving pulse, such as a sustain pulse, in a sustain period, thereby implementing images.

Meanwhile, a display filter 300 is disposed on the front surface of the plasma display panel 200.

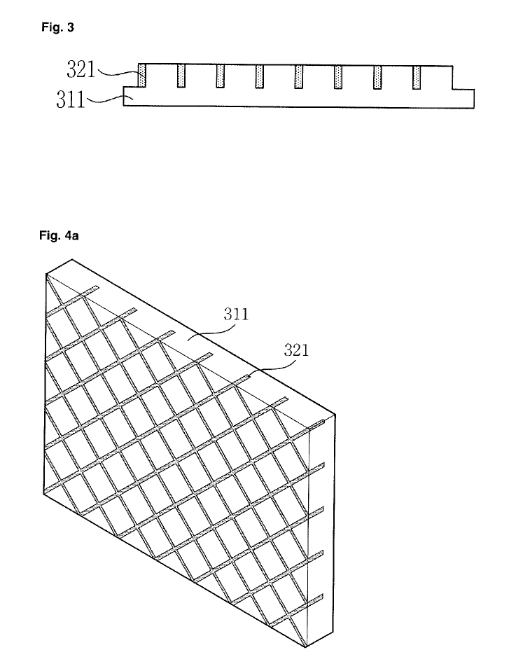

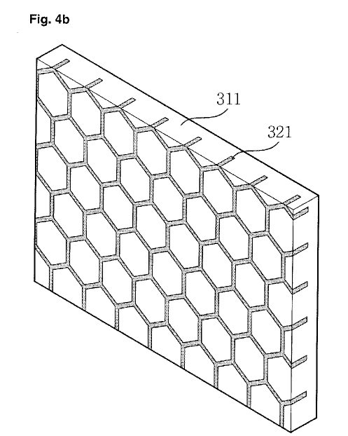

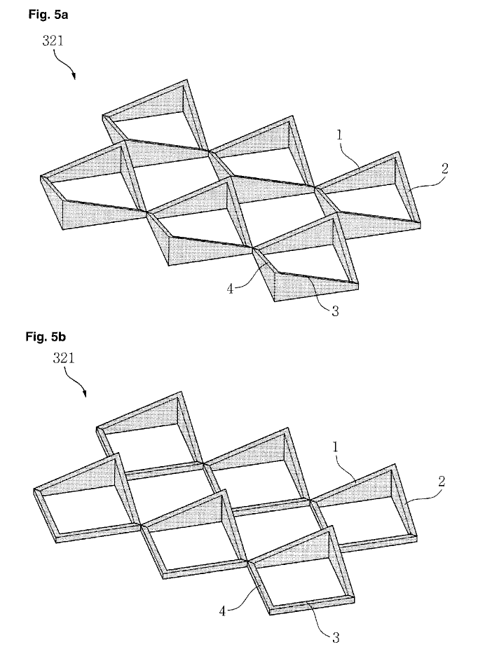

FIG. 3 is a view showing a cross section of a display filter structure according to an embodiment of the present invention. FIGS. 4a and 4b are views showing a plane of a display filter structure according to an embodiment of the present invention.

First, referring to FIG. 3, the display filter 300 comprises a base layer 311 and a metallic layer 321 of a mesh pattern disposed on the top of the base layer.

The base layer 311 is made of a transparent material, and further comprises a cushioning material having elasticity to ensure the impact resistance function and the noise prevention function. For instance, the base layer 311 comprises resin, so that noise generated upon driving the plasma display apparatus can be reduced to a certain extent, and external impact can be absorbed, thereby protecting the plasma display panel.

This resin may comprise at least only one of polymer types of polydimethylsiloxane, polymethylmethacrylate, ethylene vinyl acetate, etc.

Additionally, one or more of near infrared blocking and color temperature correction materials are added to the base layer 311, so that the base layer 311 can perform composite functions. Accordingly, the manufacturing process of a display filter can be made easier.

The thickness of the base layer may range from 30 μm to 500 μm in order to secure the supporting strength for supporting the metallic layer and the light transmittance to a certain extent when driving the plasma display panel.

The metallic layer 321 of the mesh pattern is a stereoscopic structure having a predetermined height. This stereoscopic structure may have a differential thickness over the entire parts, and may have a differential height only at some parts. This may be applied in specific regions of the entire screen of the plasma display panel depending on a difference in electromagnetic wave strength or brightness.

In addition, the surface of the metallic layer of the mesh pattern may further comprise a black type material and have a dark color. The black type material is a material with conductivity, such as carbon. In this way, once the surface of the metallic layer has a dark color, the reflection of light incident from the outside can be reduced to improve the contrast characteristic.

The thickness of the metallic layer of the mesh pattern ranges from 10 μm to 200 μm. In this value range, the metallic layer can satisfy both electromagnetic wave blocking function and the brightness characteristic of the plasma display panel.

Referring to FIGS. 4a and 4b, although the mesh pattern of the metallic layer has a rectangular or hexagonal shape, but it is not limited thereto and may have a rectangular shape. Especially, if the mesh pattern has a rectangular shape, the angle between one side of the rectangle and the horizontal reference line L of the base layer is biased. That is, the mesh pattern is formed in a diamond shape over the entire screen. The above diamond or hexagonal shapes can prevent a grid phenomenon shown on the screen upon driving the plasma display panel.

Moreover, if the mesh of the metallic layer has a polygonal shape, the height of the mesh may be changed at least one portion of the polygonal mesh, and the height of the mesh may be constant at least one portion of the polygonal mesh.

A structure of the metallic layer of this mesh pattern will be described later.

The display filter having the above-described structure mainly serves to perform the electromagnetic wave blocking function, and subsidiarily serves to perform the color correction function, external light blocking function, and near infrared blocking function.

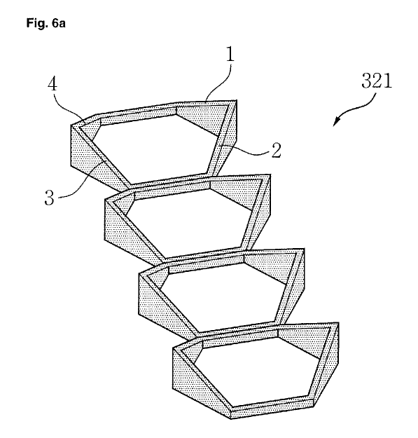

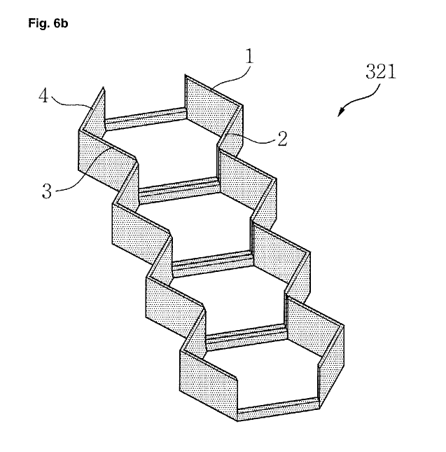

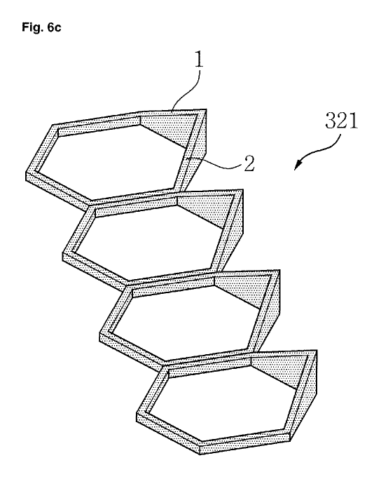

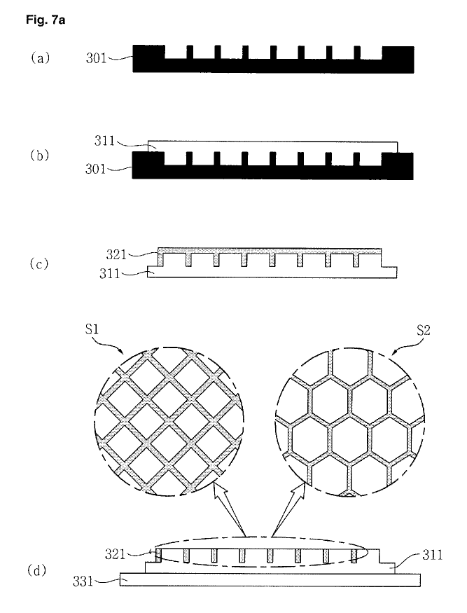

FIGS. 5a and 5b and FIGS. 6a to 6d are views stereoscopically showing a structure of a metallic layer according to an embodiment of the present invention.

First, FIGS. 5a and 5b are views showing a stereoscopic structure of a mesh pattern when the mesh pattern of a metallic layer 321 has a rectangular shape.

As shown in FIG. 5a, in a metallic layer of unit rectangles, the height of the pattern of the metallic layer 321 corresponding to a first side 1 and a second side 2 adjacent to the first side 2 symmetrically changes. Namely, the height of the pattern corresponding to two neighboring sides, e.g., the first side 1 and the second side 2 or a third side 3 and a fourth side 4, of the four sides of the rectangle may gradually decrease from the point where the two sides meet.

Further, as in FIG. 5b, the height of the other two sides 3 and 4 except the first side 1 and the second side 2 symmetrically changes.

FIGS. 6a and 6b are views showing a stereoscopic structure of a mesh pattern when the mesh pattern of a metallic layer has a hexagonal shape.

As shown in FIG. 6a, in a metallic layer of unit hexagons, the height of the pattern of the metallic layer 321 corresponding to a first side 1 and a second side 2 adjacent to the first side 2 is higher than the height of the pattern of the metallic layer corresponding to the other sides. Here, the height of the pattern of the metallic layer corresponding to the first side 1 and second side 2 of a hexagonal shape may symmetrically change. Namely, the height thereof gradually decreases from the point where the first side 1 and the second side 2 meet.

In addition, the height of the pattern of the metallic layer corresponding to a third side 3 and a fourth side 4 facing the first side 1 and second side 2 of a hexagonal shape may be greater than the height of the pattern of the metallic layer corresponding to the other sides. The height of the third side 3 and fourth side 4 also symmetrically changes, and gradually decreases from the point where they meet.

As shown in FIG. 6b, in a metallic layer of unit hexagons, the height of the pattern of the metallic layer 321 corresponding to a first side 1 and a second side 2 adjacent to the first side 2 may be greater than the height of the pattern of the metallic layer corresponding to the other sides. Here, the height of the pattern of the metallic layer corresponding to the first side 1 and second side 2 of a hexagonal shape may be constant.

In addition, the height of the pattern of the metallic layer corresponding to a third side 3 and a fourth side 4 facing the first side 1 and second side 2 of a hexagonal shape is than the height of the pattern of the metallic layer corresponding to the other sides, and is constant.

As shown in FIG. 6c, in a metallic layer of unit hexagons, the height of the pattern of the metallic layer 321 corresponding to a first side 1 and a second side 2 adjacent to the first side 2 may be greater than the height of the pattern of the metallic layer corresponding to the other sides. Here, the height of the pattern of an electromagnetic wave blocking layer 412 corresponding to the first side 1 and second side 2 of a hexagonal shape symmetrically change, and gradually decreases from the point where the two sides meet.

The height of the pattern of the electromagnetic wave blocking layer 412 corresponding to the other sides except the first side 1 and second side 2 of a polygonal shape is constant.

As shown in FIG. 6c, in a metallic layer of unit hexagons, the height of the pattern of the metallic layer 321 corresponding to a first side 1 and a second side 2 adjacent to the first side 2 may be greater than the height of the pattern of the metallic layer corresponding to the other sides. Here, the height of the pattern of an electromagnetic wave blocking layer 412 corresponding to the first side 1 and second side 2 of a hexagonal is constant. The height of the pattern of the metallic layer corresponding to the other sides except the first side 1 and second side 2 of a polygonal shape is constant.

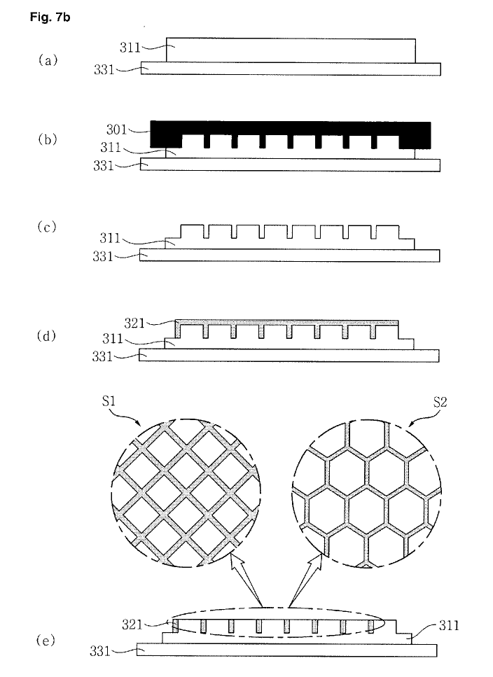

FIGS. 7a and 7b are views for explaining a manufacturing method of a display filter according to an embodiment of the present invention.

First, referring to FIG. 7a, a mold 301 having projections of a mesh pattern as in (a) is provided in order to manufacture the display filter according to the embodiment of the present invention. The height of the projections of the mold may be differential though it may be the same.

Thereafter, as in (b), resin is coated on top of the mold 301, and then dried at about 100 to 200° C. Here, as explained above, the resin may comprise at least only one of polymer types of polydimethylsiloxane, polymethylmethacrylate, ethylene vinyl acetate, etc.

Additionally, near infrared blocking and color temperature correction materials are added to the resin, so that the resin can perform various functions by using one filter layer.

After drying, the resin is removed from the mold and made into a base layer 311 of a mesh pattern having recesses. The amount of the resin is controlled so that the base layer 311 has a Young's modulus greater than 1×10 Pa and less than 1×109 Pa, thereby absorbing external impact and improving the stability of displaying.

Thereafter, an electromagnetic wave blocking material 321, such as a metallic material, is applied on the base layer 311 having recesses in a mesh pattern as in (c). For example, silver (Ag) complexed ink is applied on top of the base layer.

A carbon material may be added to the metallic layer 321 in order to improve the contrast characteristic so that the color thereof may be dark over the entire parts. Alternately, a carbon material is applied to the surface of the metallic layer and then blackened, thereby improving the contrast characteristic.

The thickness of the metallic layer 321 is differential. This thickness of the metallic layer is adjusted according to the height of the recesses of the mesh pattern formed on the base layer.

Thereafter, as in (d), a film or glass substrate 331 is attached to the rear surface of the base layer having the metallic layer, thereby completing the filter. The mesh pattern of the metallic layer 321 may be a rectangular shape S1 or hexagonal shape S2, but not limited thereto.

Meanwhile, FIG. 7b shows another example of a manufacturing method of a display filter according to an embodiment of the present invention.

Referring to FIG. 7b, resin 311 is applied on top of a film or glass substrate 331 as in (a).

As shown in FIG. 7a, the resin 311 may further comprise a cushioning material or near infrared blocking and color correction materials.

Thereafter, as in (b), a mold 301 of a mesh pattern prepared in advance is pressed on top of the resin, to form a mesh pattern having recesses in the resin.

Thereafter, as in (c), the mold is removed from the resin, and the resin is dried to form a base layer 311.

Thereafter, in steps (d) and (e), a metallic layer 321 is formed on top of the base layer in the same method as in FIG. 7a.

This method of forming a filter by using a mold has the effect of making the manufacturing process simple and reducing the manufacturing time, thereby improving the production yield. For instance, complicated and expensive processes, such as exposure, development, and sputtering, required in a conventional method can be omitted, and any particular equipment is not required unlike an offset process.

The invention being thus described, it will be obvious that the same may be varied in many ways. Such variations are not to be regarded as a departure from the scope of the invention, and all such modifications as would be obvious to one skilled in the art are intended to be included within the scope of the following claims.

What is claimed is:

1. A plasma display apparatus, comprising:
a front panel comprising scan electrodes and sustain electrodes;
a rear panel comprising data electrodes intersecting the scan electrodes and the sustain electrodes, and coupled in parallel to the front panel at a given distance therefrom;
barrier ribs disposed between the front panel and the rear panel in order to form discharge cells;
phosphors formed within the discharge cells, for emitting visible rays; and
an electromagnetic wave interference blocking filter arranged on top of the front panel,
the electromagnetic wave interference blocking filter comprising a base layer and a metallic layer of a mesh pattern disposed with a differential thickness on the base layer.

2. The plasma display apparatus of claim 1, wherein the mesh pattern of the metallic layer have a polygonal shape.

3. The plasma display apparatus of claim 2, wherein the polygon is a rectangle, and the angle between one side of the rectangle and the horizontal reference line of the base layer is a biased angle.

4. The plasma display apparatus of claim 2, wherein the height of the mesh changes at least one portion of the polygonal mesh.

5. The plasma display apparatus of claim 2, wherein the height of the mesh is constant at least one portion of the polygonal mesh.

6. The plasma display apparatus of claim 2, wherein the mesh pattern of the metallic layer have a rectangular shape, and the height of four portions of the rectangular mesh symmetrically changes.

7. The plasma display apparatus of claim 1, wherein the thickness of the metallic layer of the mesh pattern ranges from 10 μm to 200 μm.

8. The plasma display apparatus of claim 1, wherein the metallic layer of the mesh pattern has a dark color.

9. The plasma display apparatus of claim 1, wherein the base layer comprises a cushioning material.

10. The plasma display apparatus of claim 1, wherein the thickness of the base layer ranges from 30 μm to 500 μm.

11. The plasma display apparatus of claim 1, wherein the base layer has a Young's modulus greater than 1×10 Pa and less than 1×109 Pa.

12. The plasma display apparatus of claim 1, wherein the base layer comprises resin.

13. The plasma display apparatus of claim 1, wherein the base layer comprise at least one of polydimethylsiloxane, polymethylmethacrylate, and ethylene vinyl acetate.

14. The plasma display apparatus of claim 1, wherein the base layer comprises at least one of near infrared blocking materials and color correction materials.

15. The plasma display apparatus of claim 1, wherein the metallic layer comprises carbon.

16. A manufacturing method of an electromagnetic wave interference blocking filter for a plasma display apparatus, comprising:
forming a base layer having recesses of a mesh pattern by applying resin on top of a mold having projections of a mesh pattern;
forming a metallic layer of a mesh pattern by applying a metallic material on top of the base layer; and
forming a film or glass substrate on the rear surface of the base layer.

17. The plasma display apparatus of claim 16, wherein the base layer further comprises one or more of near infrared blocking materials and color correction materials.

18. The plasma display apparatus of claim 16, further comprising darkening of the metallic layer by surface treatment.

19. The plasma display apparatus of claim 16, wherein the metallic layer comprises carbon.

20. The plasma display apparatus of claim 16, wherein the thickness of the metallic layer of the mesh pattern is differential.
